(19) United States
(12) Patent Application Publication
(10) Pub. No.: US 2013/0068310 A1
(43) Pub. Date: Mar. 21, 2013

(54) Method and Apparatus for a Microfluidic Device

(71) Applicant: University of Washington through its Cent, Seattle, WA (US)

(72) Inventors: Christopher Sip, Seattle, WA (US); Albert Folch, Seattle, WA (US)

(73) Assignee: University of Washington through its Center of Commercialization, Seattle, WA (US)

(21) Appl. No.: 13/621,439

(22) Filed: Sep. 17, 2012

Related U.S. Application Data
(60) Provisional application No. 61/535,236, filed on Sep. 15, 2011.

(51) Int. Cl. F17D 1/00

(52) U.S. Cl. 137/1; 137/561 A

(57) ABSTRACT

An microfluidic device and methods for its use, where the microfluidic device comprises: (a) a porous membrane, (b) a gradient layer defining a plurality of gradient micro-channels, where the gradient layer is coupled to a top surface of the membrane, (c) a distributor layer defining a plurality of distributor micro-channels, where the distributor micro-channels are coupled to the plurality of gradient micro-channels, where the distributor layer defines at least one inlet opening and at least one outlet opening, each inlet opening and outlet opening are coupled to the plurality of distributor micro-channels, and (d) self-supporting means coupled to one or more of the porous membrane, the gradient layer and the distributor layer.

### RELATED APPLICATIONS

This application is a non-provisional of and claims priority to U.S. Provisional Application No. 61/535,236 for Method and Apparatus for a Transwell™ Microfluidic Gradient Generator for Cell Culture, filed Sep. 15, 2011, which is hereby incorporated by reference in its entirety.

### BACKGROUND OF THE INVENTION

Chemotaxis is the phenomenon whereby somatic cells, bacteria, and other single-cell or multicellular organisms direct their movements according to certain chemicals in their environment. Chemotaxis plays essential roles in many biological processes including development, inflammation, wound healing, and cancer. Conventional methods and devices employed to study chemotaxis have difficulties with cell seeding, gas and pH balance, and shear flow. In addition, these methods and devices lack standardization and ease-of-use and present difficulties in transferring technology between labs of micro-fabrication expertise and biologists.

### SUMMARY OF THE INVENTION

The present invention provides a microfluidic device that provides steady transport of soluble factors through a membrane while at the same time shielding cell cultures, tissue cultures and tissue explants from exposure to shear forces generated by this fluid flow. This capability allows the microfluidic device to maintain an unlimited source and sink of soluble factors for long-term and large-area concentration gradient generation. In one embodiment, the microfluidic device has the additional benefit of being untethered from the substrate, which allows spatial and temporal control of gradients onto conventionally prepared cell cultures, including tissue explants. This embodiment also has the benefit of allowing a different micro-fluidic device to be utilized with the same substrate. In this embodiment, the microfluidic device has the benefit of being transparent to permit real-time observations of cell morphology and migration using conventional microscopy techniques. The present invention further provides methods for use of the microfluidic device.

Thus, in a first aspect, the present invention provides a microfluidic device comprising: (a) a porous membrane, (b) a gradient layer defining a plurality of gradient micro-channels, where the gradient layer is coupled to a top surface of the porous membrane, (c) a distributor layer defining a plurality of distributor micro-channels, where the distributor micro-channels are coupled to the plurality of gradient micro-channels, where the distributor layer defines at least one inlet opening and at least one outlet opening, and each inlet opening and outlet opening is coupled to the plurality of distributor micro-channels, and (d) self-supporting means coupled to one or more of the porous membrane, the gradient layer and the distributor layer.

In one embodiment, the invention provides that the porous membrane defines substantially uniform sized pores that are aligned in a substantially straight path from the top surface of the porous membrane to a bottom surface of the porous membrane.

In a further embodiment, the invention further provides a masking layer coupled to the porous membrane.

In yet another embodiment, the invention provides that the masking layer is coupled to a bottom surface of the porous membrane and the distributor layer is coupled to a top surface of the porous membrane.

In an alternative embodiment, the invention provides that the distributor layer and the gradient layer have a stacked arrangement such that the gradient layer is disposed between the distributor layer and the porous membrane, wherein the gradient layer acts as a masking layer, and wherein the plurality of distributor micro-channels are coupled to the plurality of gradient micro-channels via ducts.

In still another embodiment, the porous membrane, the gradient layer, the distributor layer, and the self-supporting means are all transparent.

In an alternative embodiment, the porous membrane, the gradient layer, the distributor layer, and the self-supporting means are all opaque.

In a second aspect, the present invention also provides a method for generating a gradient using the microfluidic device, where the method comprises: (a) loading the microfluidic device's plurality of distributor micro-channels and the plurality of gradient micro-channels with at least a first fluid and a second fluid, wherein the first fluid and the second fluid are comprised of different concentrations of one or more soluble factors, (b) inserting the microfluidic device into a vessel containing fluid, (c) maintaining a fluid space in a range from 10 μm to 500 μm in height, via the self-supporting means, between the bottom surface of the porous membrane of the microfluidic device and a surface of the vessel, (d) diffusing the one or more soluble factors from the first fluid and the second fluid through the porous membrane into the fluid space, and (e) generating a concentration gradient in the fluid space.

In one embodiment the method further comprises the steps of substantially restricting fluid flow of the first and second fluids from the plurality of gradient micro-channels through the membrane into the vessel and, in response to restricting the fluid flow through the membrane, reducing a fluid flow shear force in the fluid space.

In another embodiment, the method further comprises the step of repositioning the microfluidic device in the vessel by one or both of rotation or translation.

In still another embodiment, the method further comprises the steps of removing the microfluidic device from the vessel, loading the microfluidic device's plurality of distributor micro-channels and plurality of gradient micro-channels with at least a third fluid and a fourth fluid, wherein the third fluid and the fourth fluid are comprised of different concentrations of one or more soluble factors, inserting the microfluidic device into the vessel, and diffusing the one or more soluble factors from the third fluid and fourth fluid through the porous membrane into the fluid space.

In a further embodiment, the method further comprises the steps of removing the microfluidic device from the vessel and placing a second microfluidic device into the vessel, where the second microfluidic device defines a different gradient micro-channel pattern than the removed microfluidic device.

In a third aspect, the present invention also provides a method for controlling the delivery of soluble factors to cell cultures using the microfluidic device, where the method comprises: (a) loading the microfluidic device's plurality of distributor micro-channels and the plurality of gradient micro-channels with a fluid containing one or more soluble factors, (b) inserting the microfluidic device into a vessel containing fluid, (c) maintaining a fluid space in a range from 10 μm to 500 μm in height, via the self-supporting means, between a bottom surface of the porous membrane and a surface of the vessel, (d) diffusing the one or more soluble factors from the fluid through the porous membrane into the fluid space, and (e) maintaining a substantially uniform concentration of soluble factors at the surface of the vessel.

### BRIEF DESCRIPTION OF THE DRAWINGS

FIG. 1A is an isometric view of the microfluidic device in accordance with one embodiment of the invention with a stacked arrangement of the distributor layer and the gradient layer.

FIG. 1B is an isometric view of the distribution layer, gradient layer, and the membrane without the self-supporting means.

FIG. 1C is a bottom view of the microfluidic device without the porous membrane.

FIG. 1C, Detail B is a detail bottom view of distributor micro-channels and gradient micro-channels and two inlet openings.

FIG. 1C, Section A-A is cross-sectional side view of the microfluidic device.

FIG. 1C, Section A-A, Detail C is a detail cross-sectional side view of the porous membrane, gradient micro-channels, distributor micro-channels and ducts.

FIG. 1D is a side view of the microfluidic device.

FIG. 1E is an exploded isometric view of the distributor layer, the gradient layer and the porous membrane.

FIG. 1F is an isometric view of the microfluidic device and an example receiving vessel according to one embodiment of the invention.

FIG. 1G is a bottom view of the microfluidic device disposed within an example receiving vessel.

FIG. 1G, Section E-E is a cross-sectional side view of the microfluidic device disposed within an example receiving vessel.

FIG. 1G, Section E-E, Detail G is a detail cross-sectional side view of a fluid space maintained between the microfluidic device and an example receiving vessel.

FIG. 1H is a bottom view, generated using finite-element modeling, of a concentration gradient in a fluid space corresponding to the gradient micro-channel embodiment of FIGS. 1A-G, where the concentration gradient is depicted with contour lines in 10% intervals.

FIG. 2A is an isometric view of the microfluidic device in accordance with another embodiment of the invention with a stacked arrangement of the distributor layer and the gradient layer.

FIG. 2B is an isometric view of the distribution layer, gradient layer, and the porous membrane without the self-supporting means.

FIG. 2C is a bottom view of the microfluidic device without the porous membrane.

FIG. 2C, Detail B is a detail bottom view of distributor micro-channels and gradient micro-channels and one outlet opening.

FIG. 2C, Section A-A is cross-sectional side view of the microfluidic device.

FIG. 2C, Section A-A, Detail C is a detail cross-sectional side view of the porous membrane, gradient micro-channels, distributor micro-channels and ducts.

FIG. 2D is a side view of the microfluidic device.

FIG. 2E is a bottom view of the microfluidic device disposed within an example receiving vessel.

FIG. 2E, Section E-E is a cross-sectional side view of the microfluidic device disposed within an example receiving vessel.

FIG. 2E, Section E-E, Detail G is a detail cross-sectional side view of a fluid space maintained between the microfluidic device and an example receiving vessel.

FIG. 2F is a bottom view, generated using finite-element modeling, of a concentration gradient in a fluid space corresponding to the gradient micro-channel embodiment of FIGS. 2A-E, where the concentration gradient is depicted with contour lines in 10% intervals.

FIG. 3A is an isometric view of the microfluidic device in accordance with one embodiment of the invention with a distributor layer and a gradient layer lying in the same plane, both coupled to a top surface of a porous membrane, and a masking layer coupled to a bottom surface of the porous membrane.

FIG. 3B is an isometric view of the distribution layer, gradient layer, porous membrane and masking layer without the self-supporting means.

FIG. 3C is a bottom view of the microfluidic device with the masking layer.

FIG. 3C, Detail B is a detail bottom view of distributor micro-channels and gradient micro-channels and the masking layer.

FIG. 3C, Section A-A is cross-sectional side view of the microfluidic device.

FIG. 3C, Section A-A, Detail C is a detail cross-sectional side view of the porous membrane, gradient micro-channels, distributor micro-channels and ducts.

FIG. 3D is a side view of the microfluidic device.

FIG. 3E is a bottom view, generated using finite-element modeling, of a concentration gradient in a fluid space corresponding to the gradient micro-channel embodiment of FIGS. 3A-D, where a first concentration gradient is depicted with contour lines in 10% intervals and a second concentration gradient is depicted with dotted contour lines in 10% intervals.

Chart 1 shows surface gradient characterization of a 16-channel microfluidic device designed for standard 6-well plates.

Chart 2 shows surface gradient characterization of an 8-channel microfluidic device designed for glass-bottom 6-well plates.

Chart 3 shows calcein AM green staining of a nearly confluent layer of CHO-K1 cells with a microfluidic device demonstrates a gradient in the uptake of dye.

Chart 4 shows traces of axon growth cones from a retinal explant cultured in the presence of an 8-Br-cAMPS gradient over the course of 13 hours.

Chart 5 shows traces of axon growth cones of E18 embryonic hippocampal neurons in response to a gradient of 8-Br-cAMPS over the course of 24 hours.

### DETAILED DESCRIPTION OF THE INVENTION

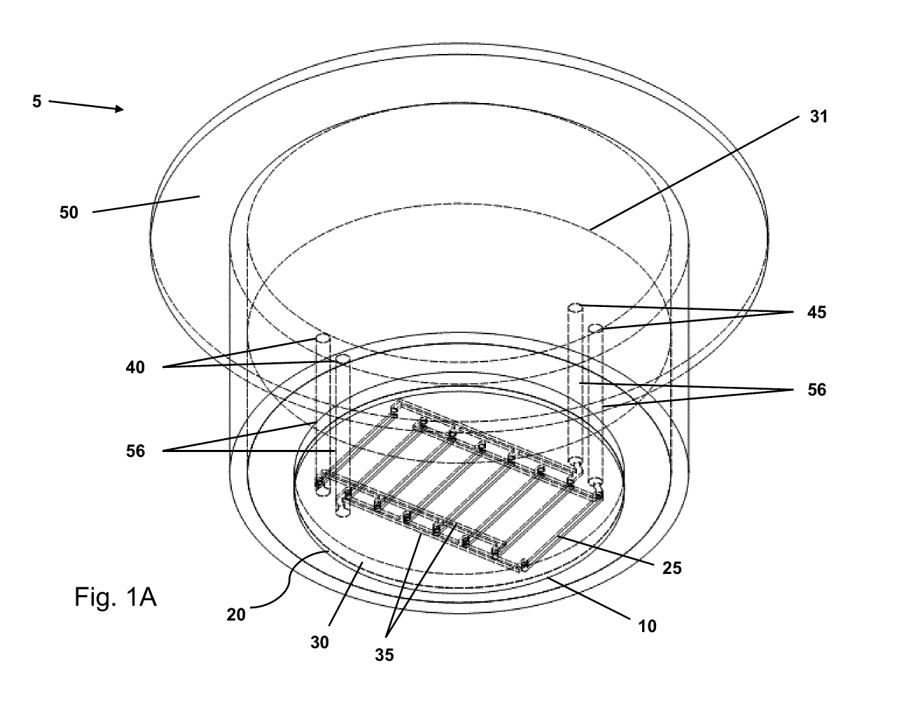

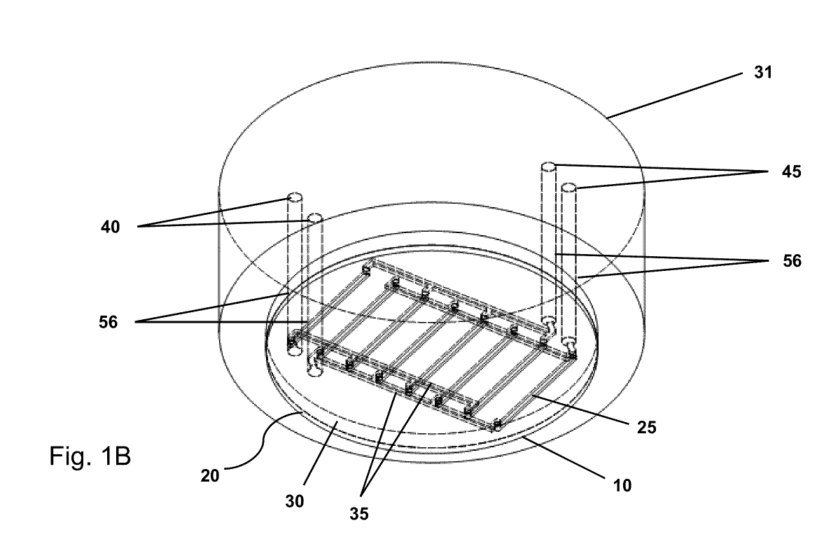

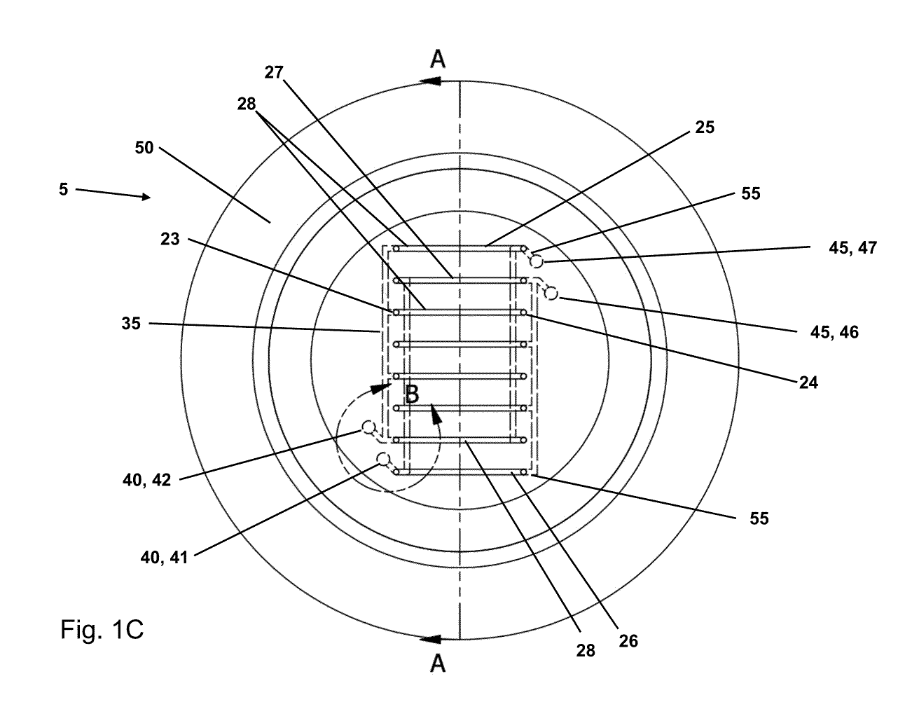

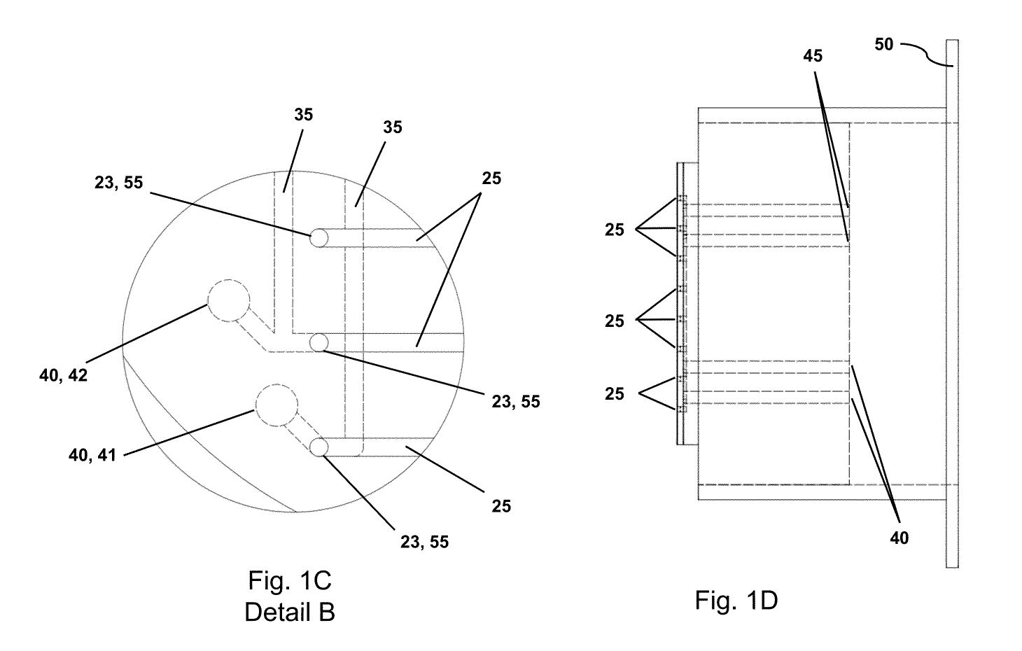

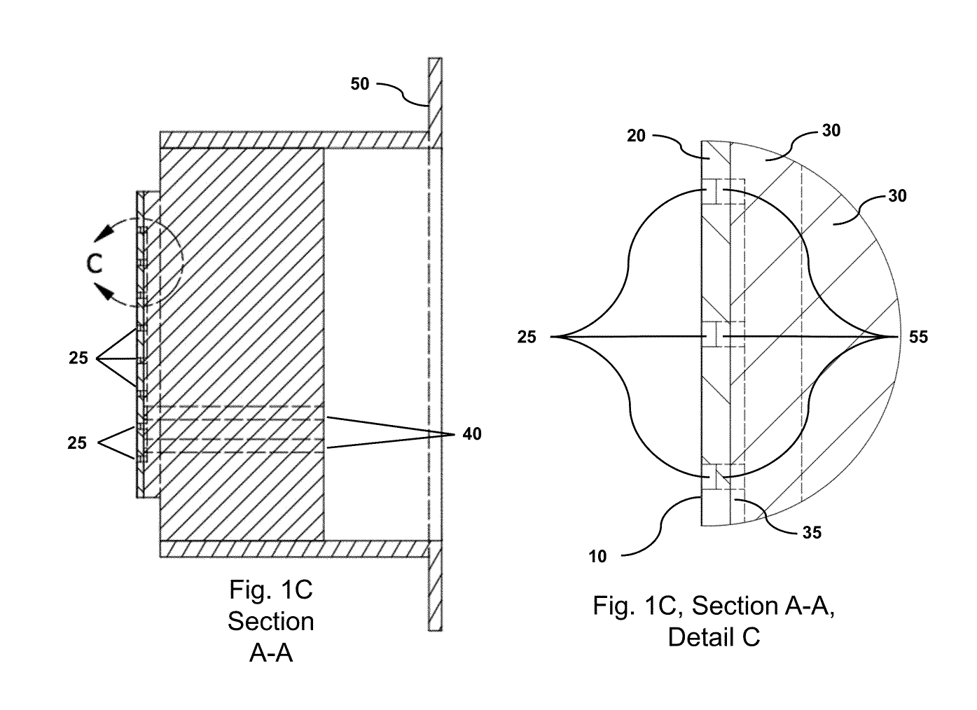

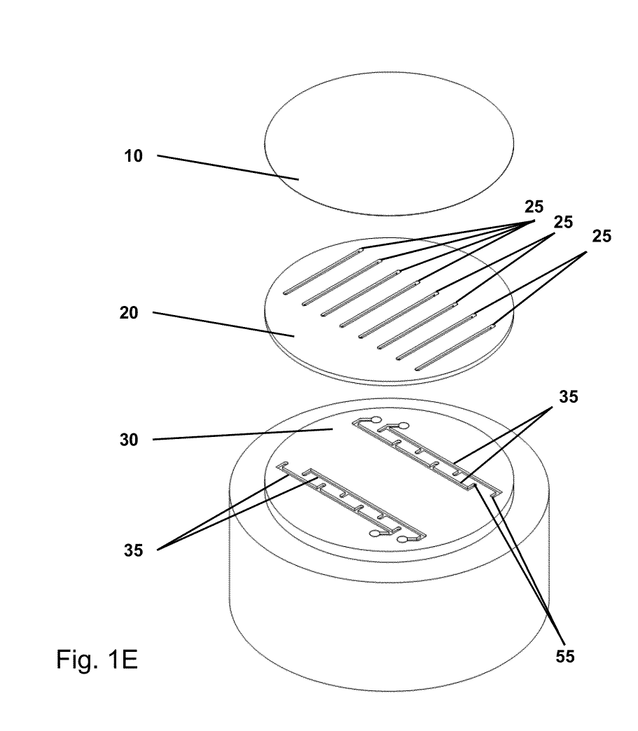

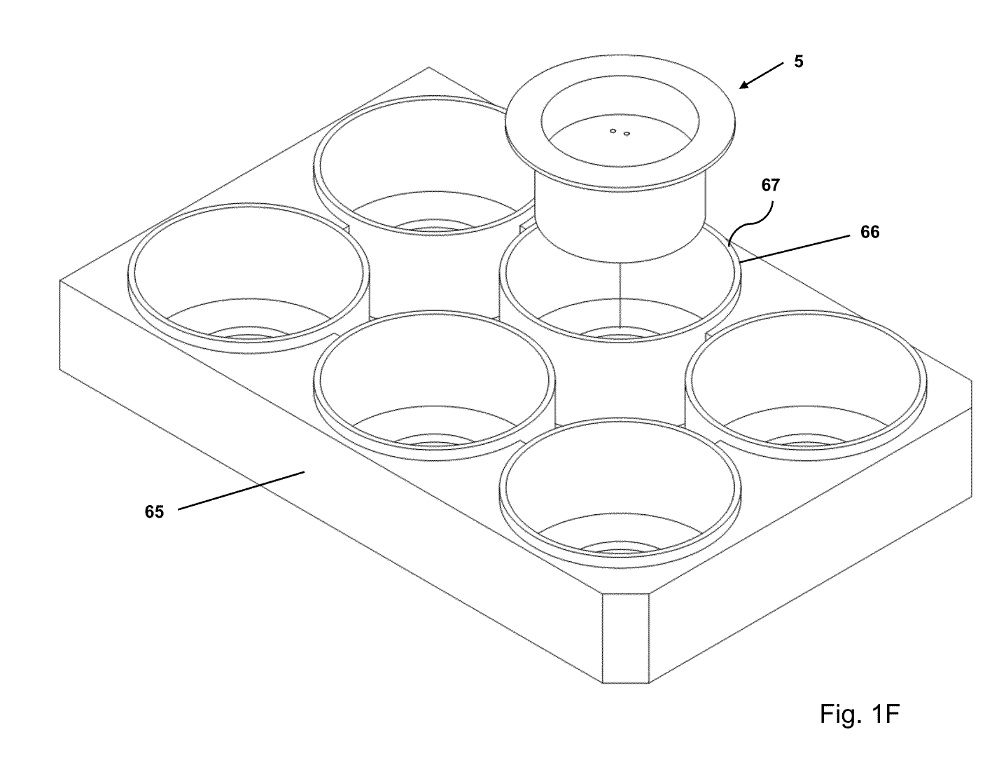

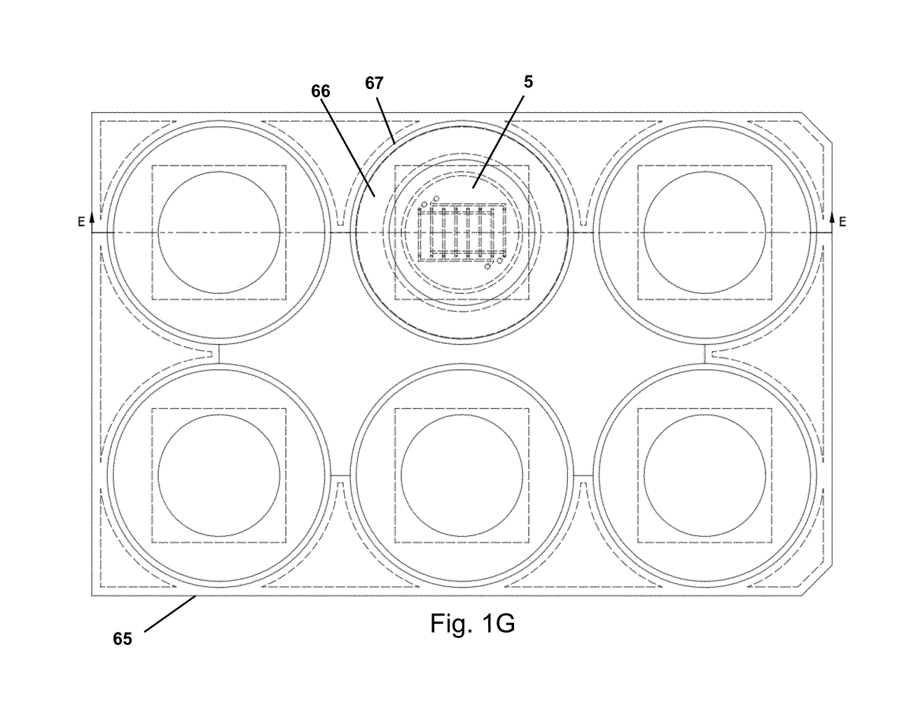

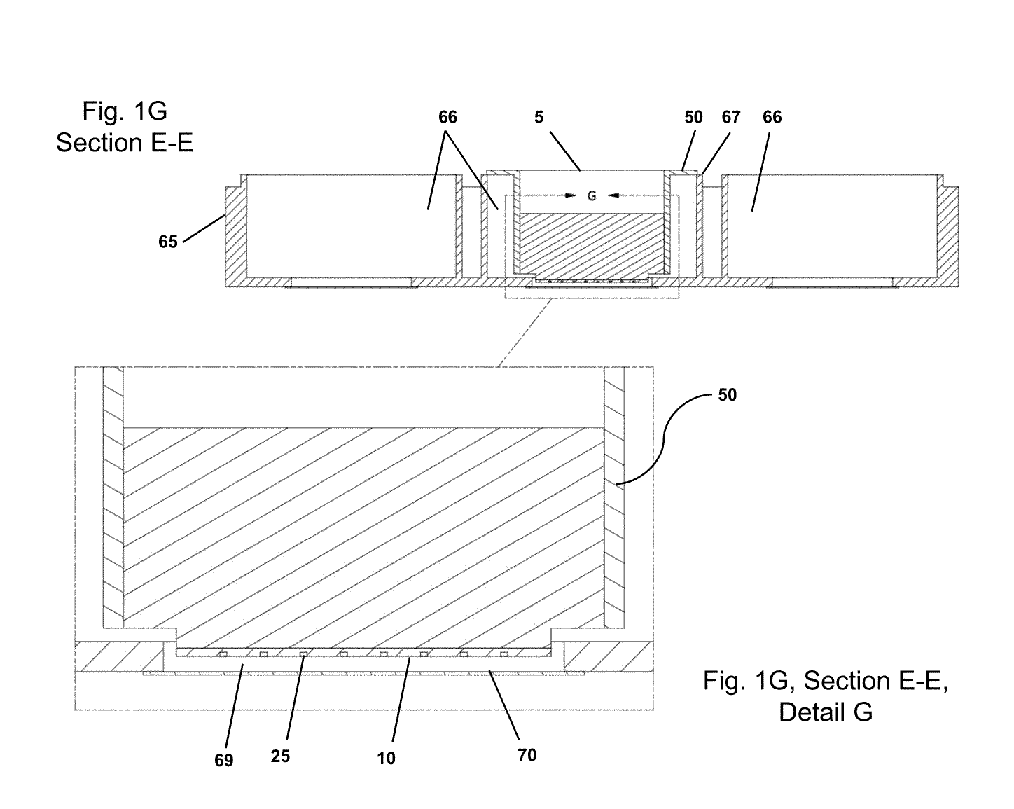

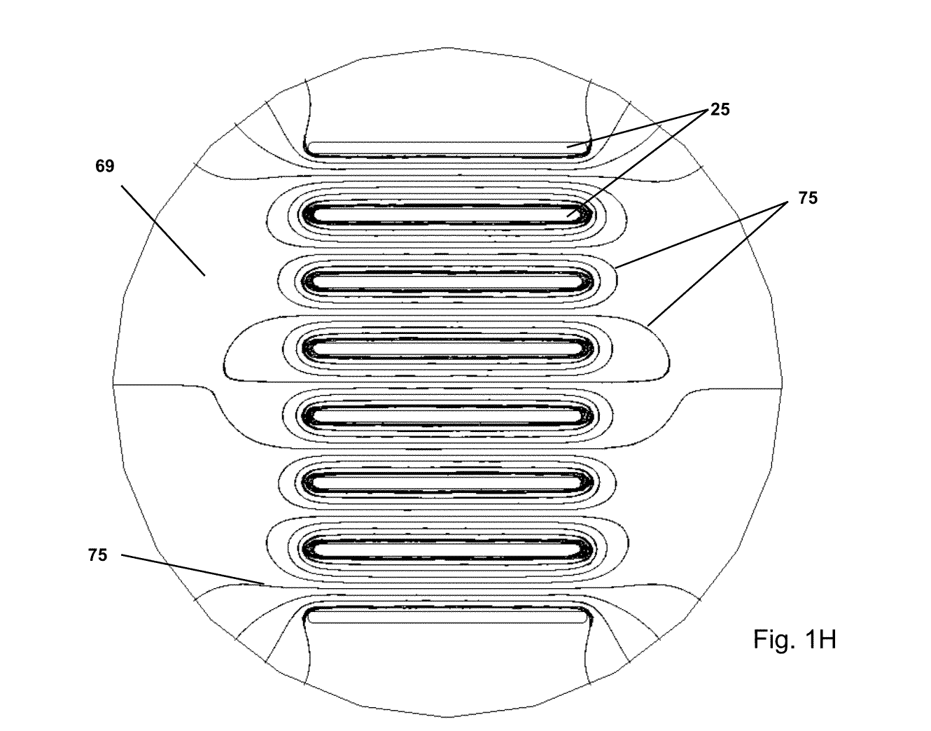

In a first aspect, as shown in FIGS. 1A-G, 2A-2E, and 3A-3D, the present invention may take the form of a microfluidic device 5 comprising: (a) a porous membrane 10, (b) a gradient layer 20 defining a plurality of gradient micro-channels 25, where the gradient layer 20 is coupled to a top surface of the membrane, (c) a distributor layer 30 defining a plurality of distributor micro-channels 35, where the distributor micro-channels 35 are coupled to the plurality of gradient micro-channels 25, where distributor layer 30 defines at least one inlet opening 40 and at least one outlet opening 45, and each inlet opening 40 and outlet opening 45 is coupled to the plurality of distributor micro-channels 35, and (d) self-supporting means 50 coupled to the microfluidic device 5.

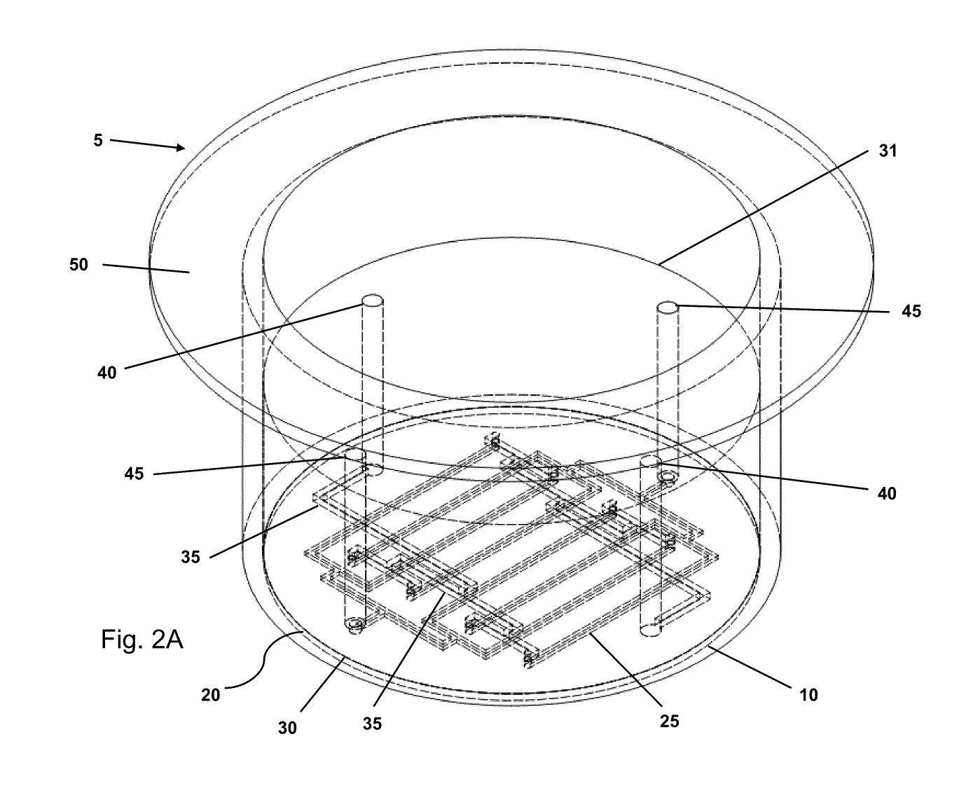

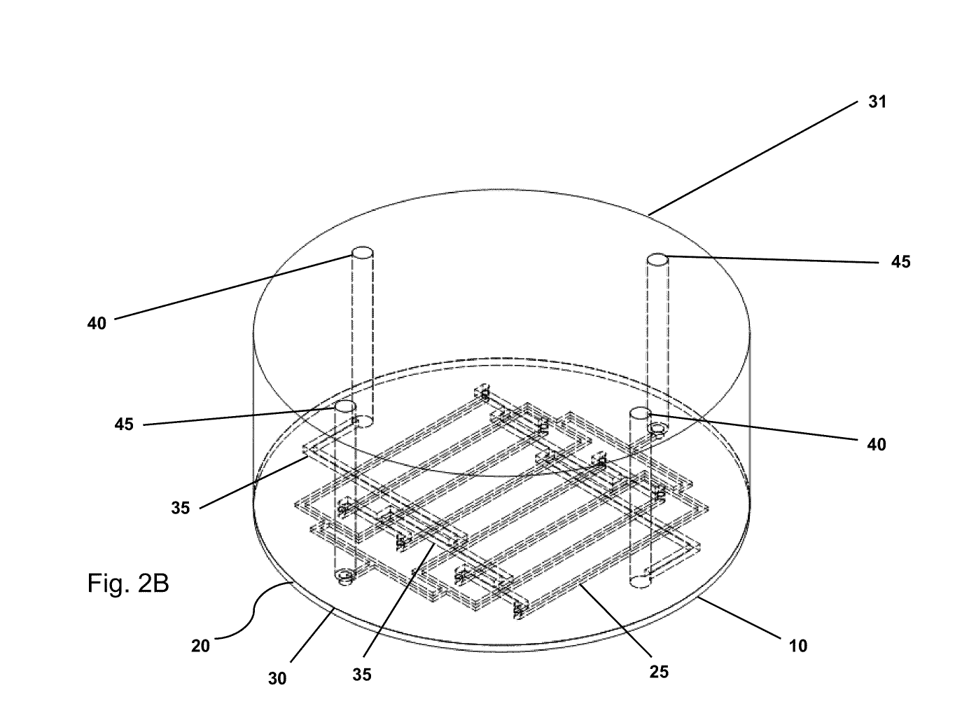

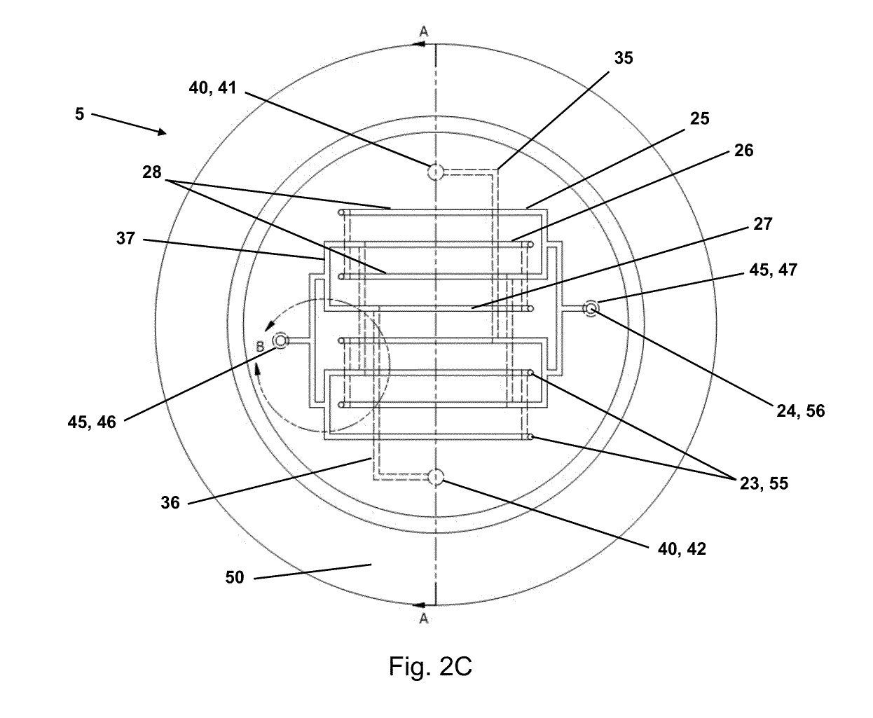

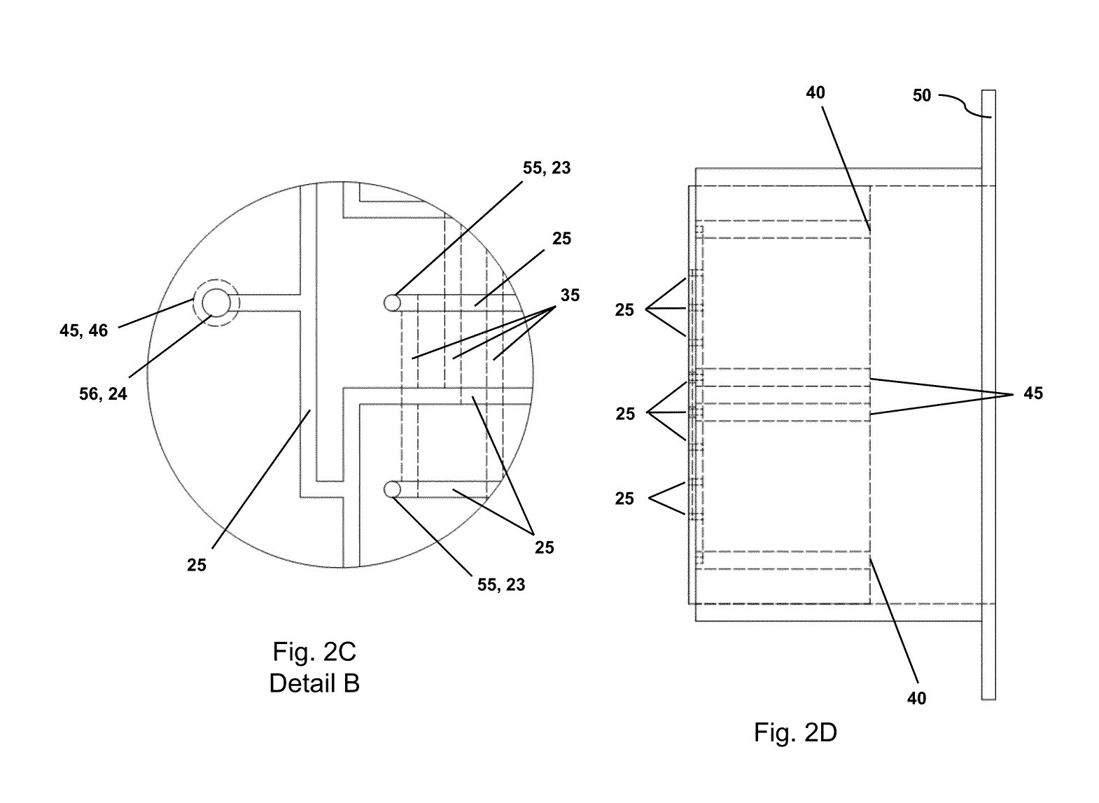

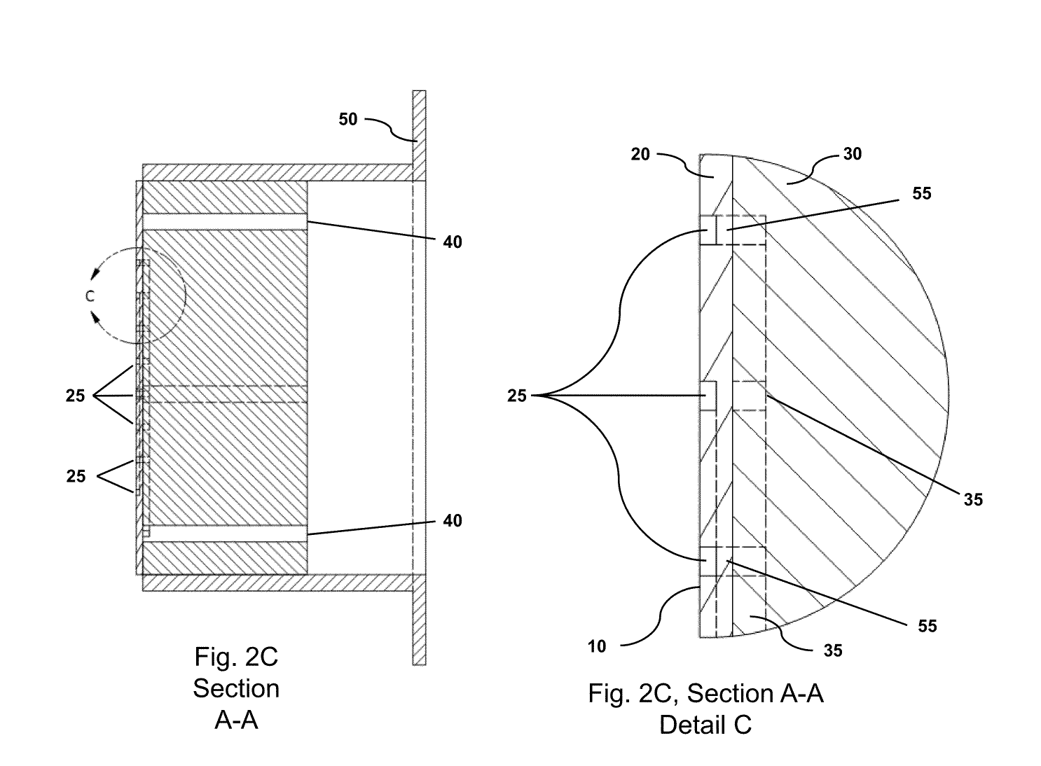

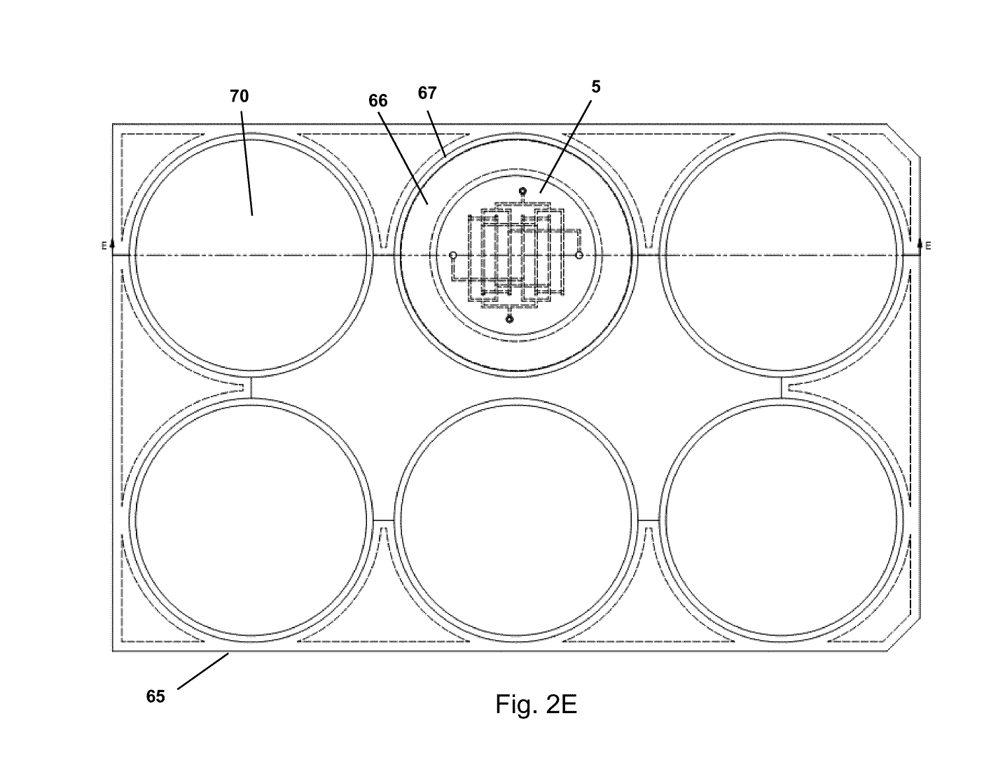

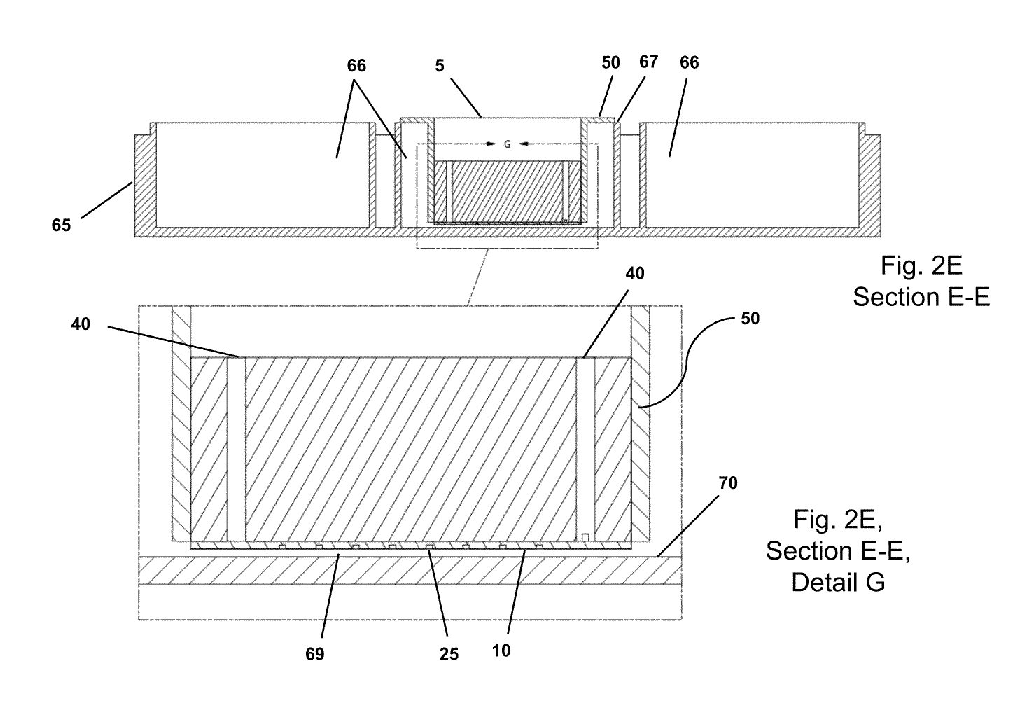

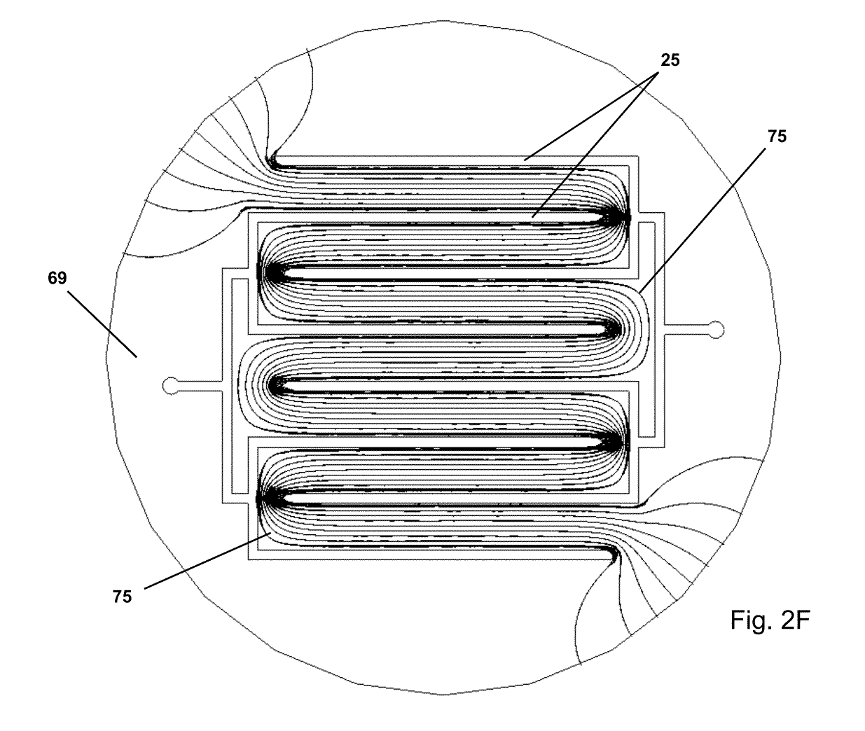

As used herein, a “microfluidic device” is designed for use in a range of culture vessels 65, for example, a well 66 in a standard multi-well plate 65 (see FIGS. 1F-1G, 2E), a cell culture dish or flask, or any other cell culture dish known in the art, regardless of shape, but including cylindrical, rectangular or octagonal shaped vessels 65. The vessel 65 may further comprise transparent glass or plastic, for example. The vessel surface 70 is preferably a substrate prepared with biological samples, cell cultures or tissue cultures.

In operation, the microfluidic device 5 maintains a fluid space 69, via self-supporting means 50, between the porous membrane 10 and a vessel surface 70, such that fluid flowing through the plurality of gradient micro-channels 25 diffuses soluble factors through the porous membrane 10 in the fluid space 69, as further detailed below (see FIG. 1G). In this arrangement, the microfluidic device 5 can be used to generate a concentration gradient 75, as shown in FIGS. 1H, 2F, and 3E, to control the concentration of soluble factors for dosage delivery, or to exchange solutions between a cellular culture/suspension disposed within the vessel 65 with one or more fluids flowing through the microfluidic device 5, for example.

As used herein, a “porous membrane” 10 has a thickness ranging from 5 μm to 200 μm, and is preferably 10-12 μm thick (see FIG. 1E). In addition, the bottom surface of the membrane 10 is substantially planar or flat with a preferred tolerance of ±20 μm. The flatness of the membrane's bottom surface directly impacts gradient generation. Specifically, as this tolerance is relaxed, the membrane surface can be closer than anticipated to the cellular culture or suspension in random unpredictable locations, which renders the slope of the various gradients generated less reliable.

In one preferred embodiment, the membrane 10 is track-etched such that the porous membrane 10 defines substantially uniform sized pores that are aligned in a substantially straight path from the top surface of the membrane to the bottom surface of the membrane. The substantially uniform sized pores have a nominal diameter ranging from 20 nm to 14 μm with a typical tolerance of ±20%. In addition, the substantially uniform sized pores have a density (or porosity) ranging from 1×10⁵ pores/cm² to 6×10⁸ pores/cm². The preferred pore size and density is selected based on the hydraulic resistance required between the microfluidic device 5 and the vessel 65. The membrane is preferably made of polyethylene terephthalate (PET), but could also be made of polycarbonate (PC), polypropylene (PP), allyl diglycol carbonate (ADC), or polyvinylidene fluoride (PVDF). While a track-etched membrane is preferred, because it provides a non-tortuous path for the soluble factors to travel into a culture vessel 65, other porous membranes such as fibrous or cellulose are suitable for use with the microfluidic device 5.

As used herein, a “gradient layer” 20 is a substantially solid construct that defines a plurality of gradient micro-channels 25. The gradient layer 20 may be composed of Polydimethylsiloxane (PDMS) and manufactured using soft lithography or, alternatively, may be composed of a thermoset polymer such as polystyrene (PS), PC, PET, silicones, fluorinated polymers and manufactured via injection molding. Additionally, the gradient layer 20 may be manufactured using etching, milling, or other machining processes from solid materials such as plastic or glass.

As used herein, a “plurality of gradient micro-channels” 25 are open on one side such that, when the gradient layer 20 is coupled to the top surface of the membrane 10, the membrane 10 seals the open side of the gradient micro-channels 25 acting as a sort of base. This arrangement accordingly places any fluid that flows through the gradient micro-channel 25 in direct contact with the membrane 10. This in turn allows soluble factors contained within the fluid to diffuse through the membrane 10 and to communicate with the fluid space 69 in the culture vessel 65.

In one preferred embodiment, the plurality of gradient micro-channels 25 are substantially parallel to one another (see, e.g., FIGS. 1C, 2C). In this arrangement, a top surface of the distributor layer 31 defines a first inlet opening 41 and a second inlet opening 42 and defines a first outlet opening 46 and a second outlet opening 47. Here, the plurality of parallel gradient micro-channels 25 are arranged such that a first gradient micro-channel 26 and every other micro-channel thereafter 27 is coupled to both the first inlet opening 41 and the first outlet opening 46, while the remaining gradient micro-channels 28 are coupled to both the second inlet opening 42 and the second outlet opening 47. This arrangement enables the generation of a parallel array of linear concentration gradients at the vessel surface (see FIGS. 1H, 2F).

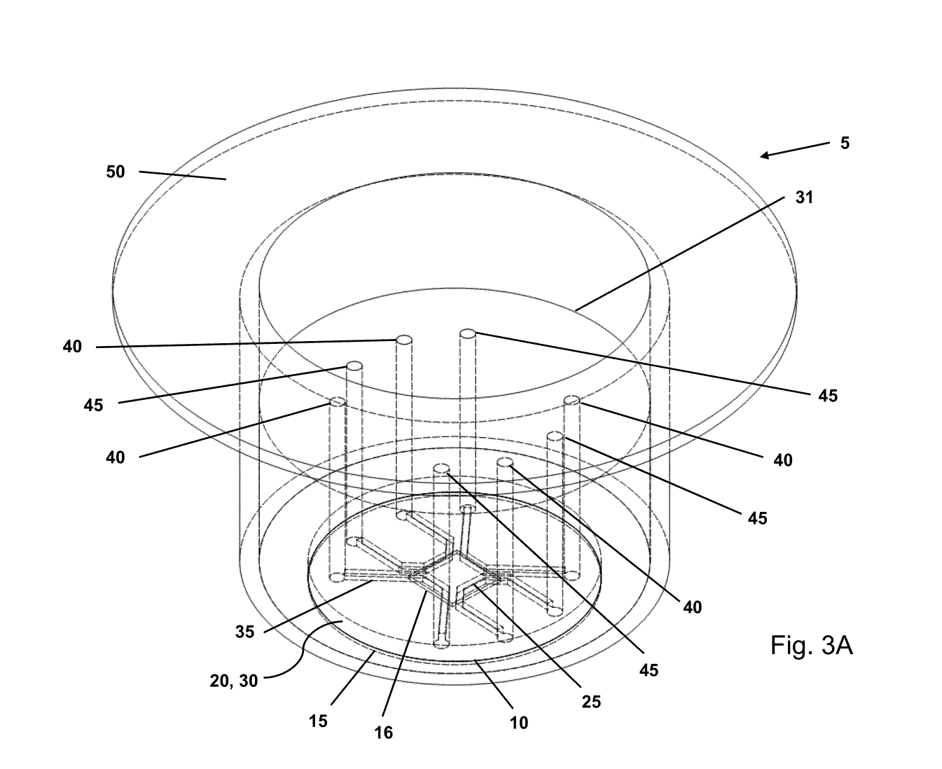

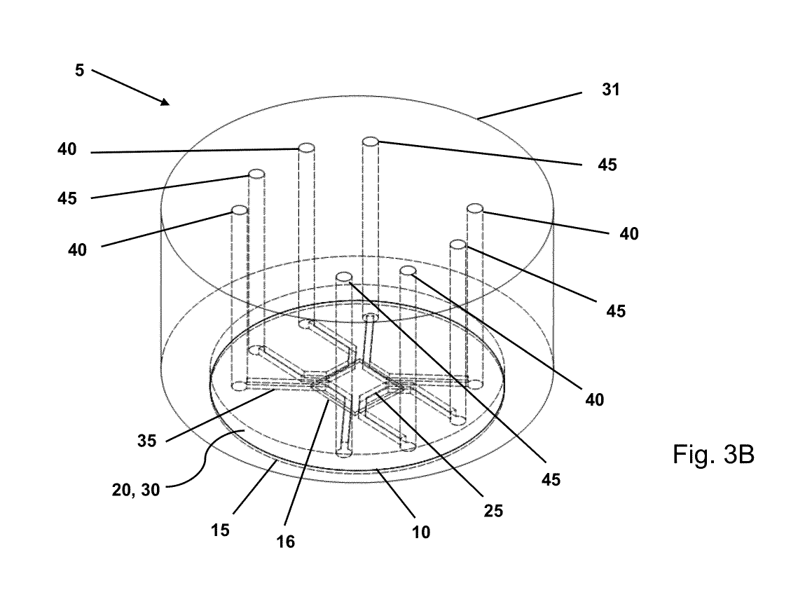

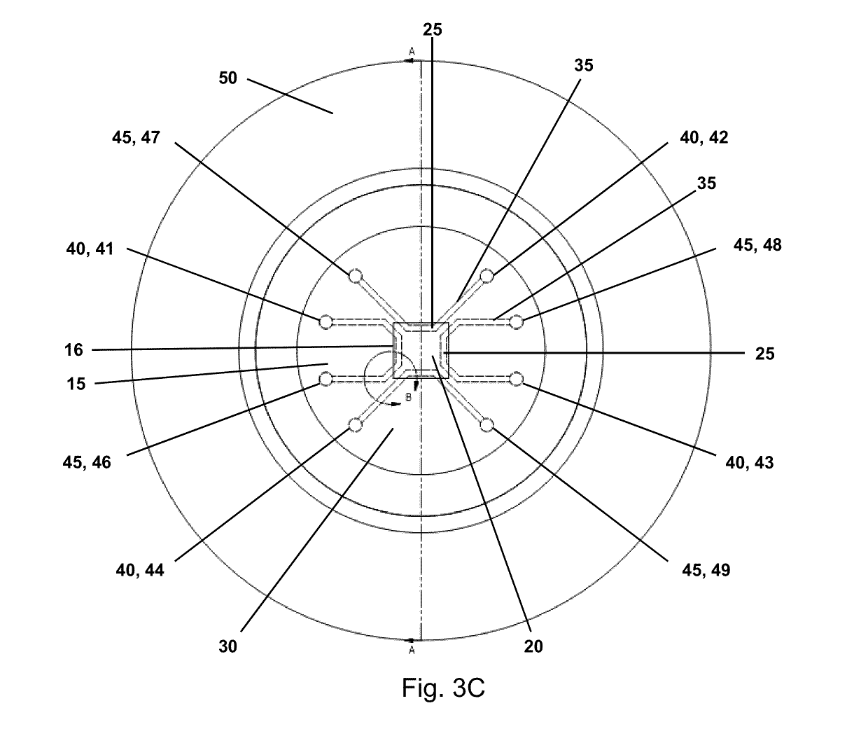

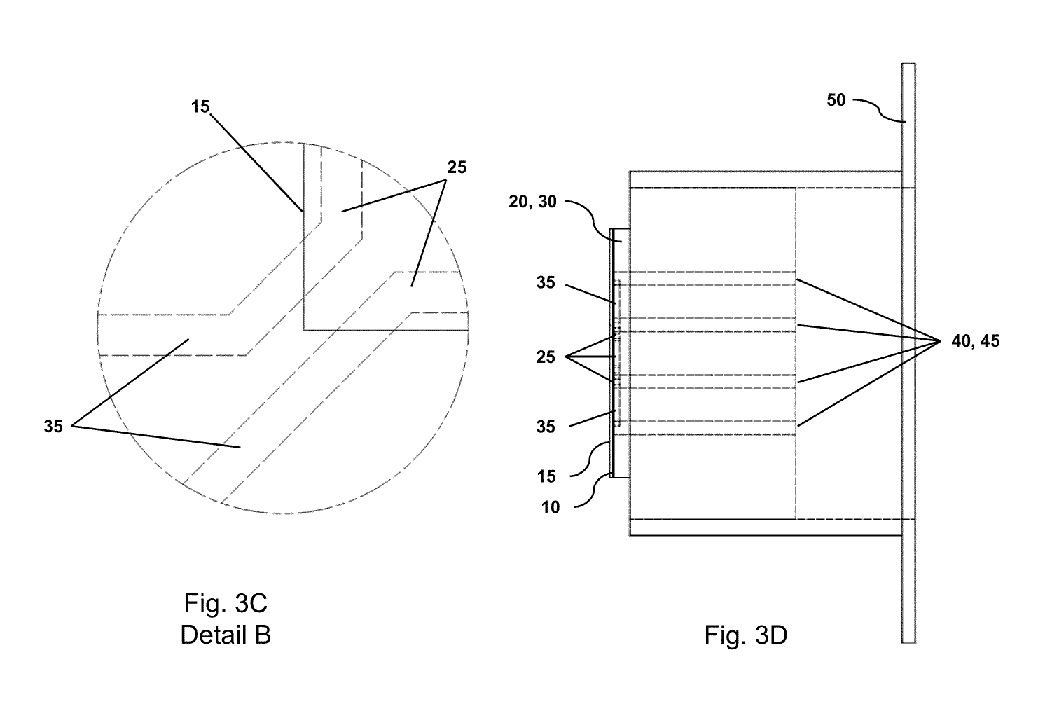

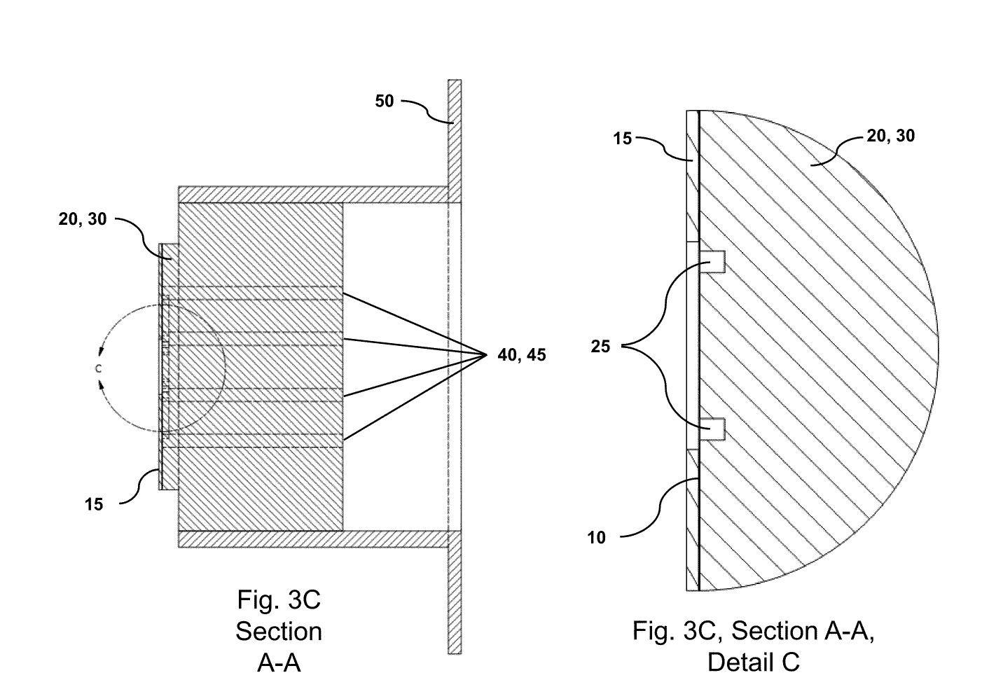

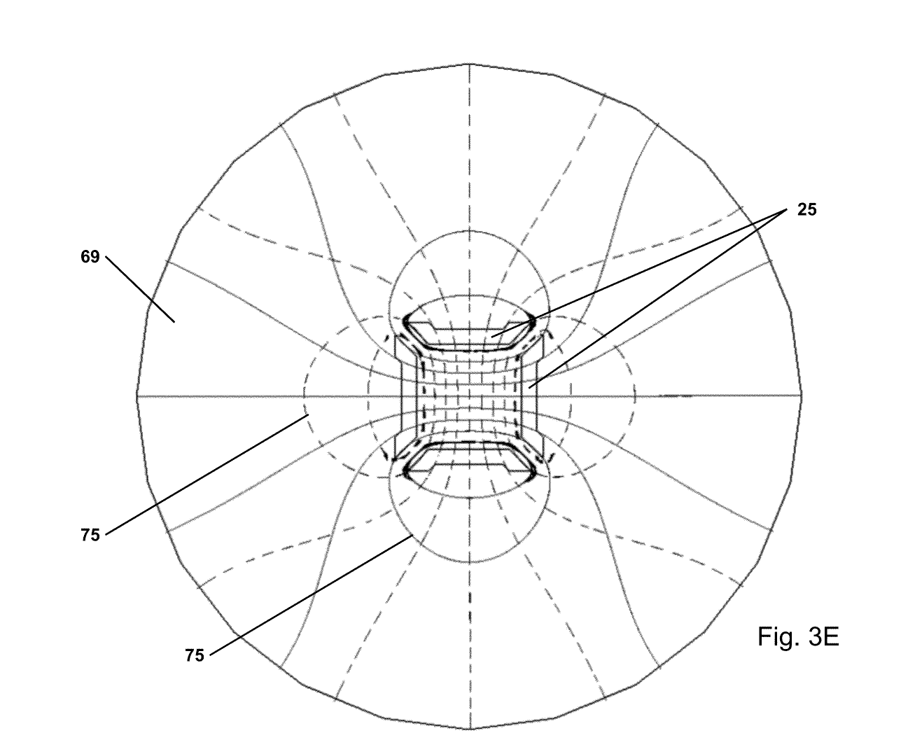

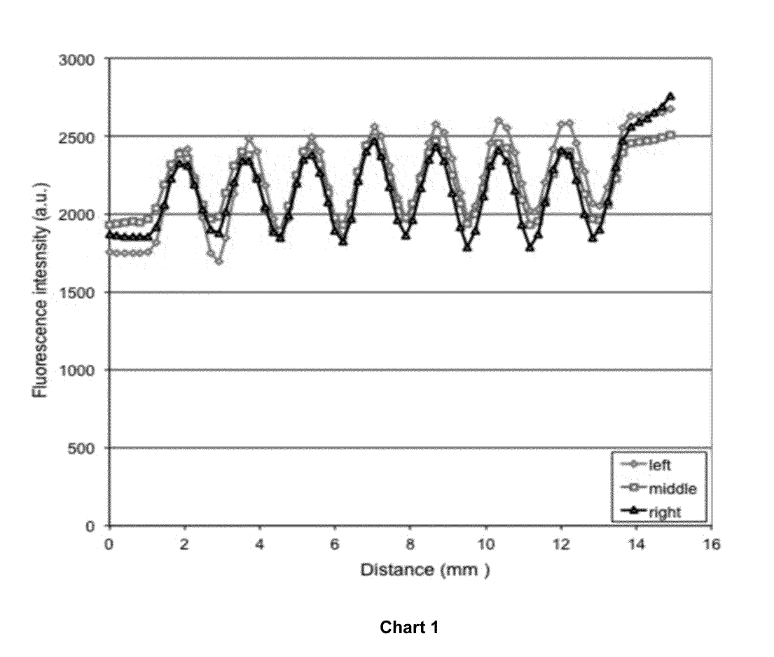

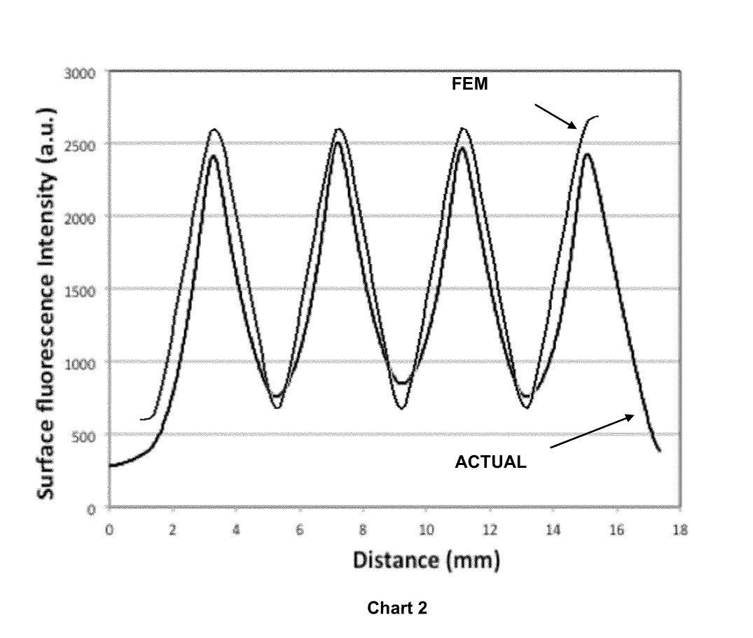

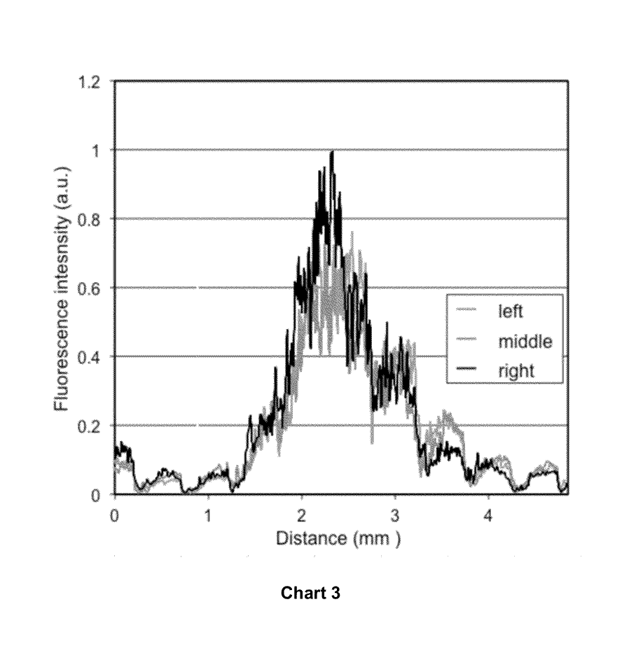

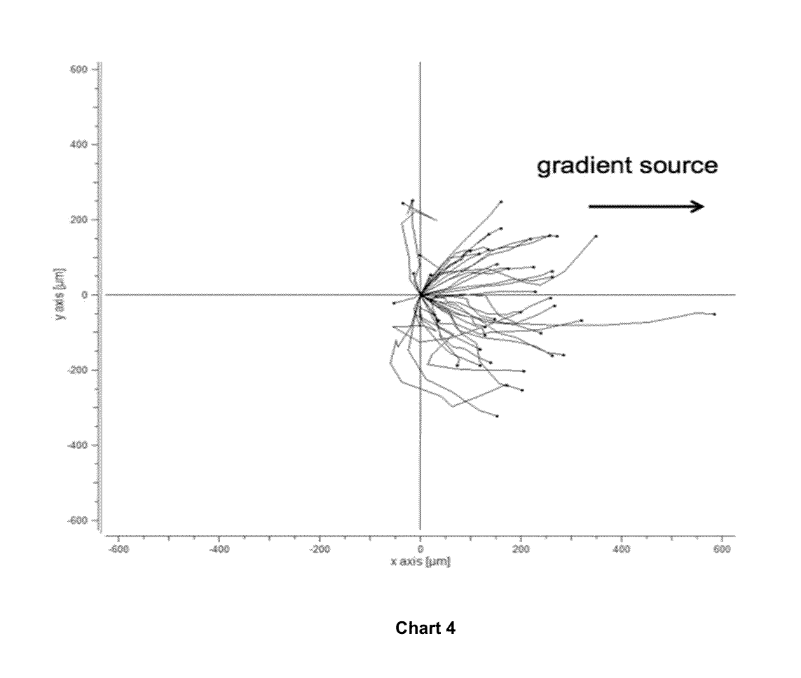

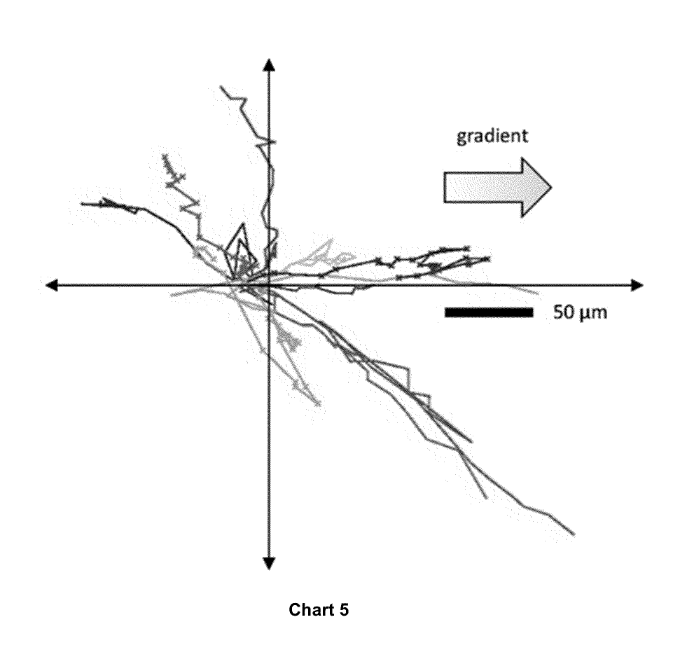

In another preferred embodiment (FIGS. 3A-3D), the top surface of the distributor layer defines a first inlet opening 41 and a second inlet opening 42 and defines a first outlet opening 46 and a second outlet opening 47. Here, a portion of the gradient micro-channels 25 coupled to both the first inlet opening 41 and the first outlet opening 46 are substantially perpendicular to a portion of the gradient micro-channels 25 coupled to both the second inlet opening 42 and the second outlet opening 47. In addition, the top surface may further define a third inlet opening 43 and fourth inlet opening 44 and define a third outlet opening 48 and a fourth outlet opening 49, where a portion of the gradient micro-channels 25 coupled to both the third inlet opening 43 and the third outlet opening 48 are substantially perpendicular to a portion of the gradient micro-channels 25 coupled to both the fourth inlet opening 44 and the fourth outlet opening 49. This arrangement enables the generation of multiple gradients that are perpendicular in orientation with respect to each other (see FIG. 3E).

As used herein, a “distributor layer” 30 is a substantially solid construct that defines a plurality of distributor micro-channels 35. The distributor layer 30 may be composed of Polydimethylsiloxane (PDMS) and manufactured using soft lithography or, alternatively, may be composed of a thermoset polymer such as polystyrene (PS), PC, PET, silicones, fluorinated polymers and manufactured via injection molding. Additionally it may be manufactured using etching, milling, or other machining process from solid materials such as plastics or glass.

As used herein, a “plurality of distributor micro-channels” 35 are enclosed conduits. The distributor micro-channels 35 convey fluids from one or more inlet openings 40 through ducts 55 to a first end 23 of the gradient micro-channels 25 (see, e.g., FIG. 1C). The fluid passes through the gradient micro-channels 25 to a second end 24, where the fluid exits the gradient micro-channels 25 either through ducts 55 (FIG. 1C), a common duct 56 (FIG. 2C) or directly (FIG. 3C) into the distributor micro-channels 35. The fluid then exits the distributor micro-channels 35 at one or more outlet openings 45. The distributor micro-channels 35 may be arranged, for example, in a straight-line (FIG. 1C) or in a binary network (FIG. 2C).

The gradient micro-channels 25 and distributor micro-channels 35 range from 10 μm to 10 mm in width and from 10 μm to 10 mm in height and preferably range from 10 μm to 350 μm in width and range from 15 μm to 400 μm in height. The gradient micro-channels 25 and distributor micro-channels 35 may share the same the same dimensions or may be different depending on the desired flow characteristics.

As used herein, a “masking layer” 15 is a layer of PDMS or thermoset polymer, for example, disposed between the distributor layer 30 and the fluid space 69 in the vessel 65 (see FIG. 3C). This masking layer 15 prevents fluid that is flowing through the distributor micro-channels 35 from passing soluble factors through the membrane 10 into the fluid space 69 of a culture vessel 65. As such, the masking layer 15 is aligned under the plurality of distributor micro-channels 35. The masking layer 15 may range from 10 μm to 400 μm in thickness and is preferably 50 μm thick. As discussed below, the architecture of the gradient layer 20 and distributor layer 30 governs whether the masking layer 15 is coupled to the top surface or the bottom surface of the membrane 10.

In one preferred embodiment shown in FIGS. 1A-G, 2A-2E, the gradient layer 20 and the distributor layer 30 have a stacked arrangement such that the gradient layer 20 is disposed between the distributor layer 30 and the membrane 10. In this embodiment, the gradient layer 20 acts as the masking layer 15. In the embodiment of FIGS. 1A-G, the plurality of distributor micro-channels 35 are coupled to the plurality of gradient micro-channels 25 via ducts 55. In the embodiment of FIGS. 2A-2E, a portion 36 of the plurality of distributor micro-channels 35 that are directly coupled to the inlet opening 40 also are coupled to the plurality of gradient micro-channels 25 via ducts 55, whereas the portion 37 of the plurality of distributor micro-channels 35 which are binary-branched are coupled directly to the outlet opening 45. In this case the entire binary-branched portion 37 of the distributor micro-channels 35 is in contact and communication with the porous membrane 10 without an underlying masking layer 15. This arrangement does not affect generation of a gradient pattern in the fluid space 69 underneath the inter-digitated gradient micro-channels 25, because the binary-branched portion of the distributor micro-channels 35 is distant from the area of interest.

In another preferred embodiment shown in FIGS. 3A-3D, the gradient layer 20 and the distributor layer 30 lie in the same plane, both coupled to the top surface of the membrane 10, while a separate masking layer 15 is coupled to the bottom surface of the membrane 10. In the example shown in FIGS. 3A-3D, the masking layer 15 is circular in shape and defines a square opening 16 in its center. The square opening 16 allows the portion of the membrane 10 underlying the plurality of gradient micro-channels 25 to be in communication with the fluid space 69 of the vessel 65. The masking layer 15 can comprise any shape and may be continuous or discontinuous in accordance with the pattern of the plurality of gradient micro-channels 25. By way of example, the masking layer 15 could also define an open channel down its center (not shown) extending from one edge of the microfluidic device 5 to the other.

As used herein, the term “layer” is not intended to indicate separate and distinct tiers within the microfluidic device 5. For example, the distributor layer 30 and the gradient layer 20 may be injection molded as a single component for either of the stacked (FIGS. 1A-G, 2A-2E) or planar arrangements (FIGS. 3A-3D). Moreover, in the stacked arrangement shown in FIGS. 2A-2E, the distributor layer 30 may be arranged such that an inlet portion 36 of the plurality of distributor micro-channels 35 is disposed above the gradient layer 20, while the outlet portion 37 of the plurality of distributor micro-channels 35 lies in the same plane as the gradient layer 20 (see FIG. 2C). Furthermore, in the planar arrangement, the gradient layer 20 and the distributor layer 30 are, for all intents and purposes, the same layer, and the plurality of gradient micro-channels 25 and the plurality of distributor micro-channels 35 are discrete components of one continuous channel. As such, as shown in FIG. 3C, the portion of this single gradient/distributor layer that overlies the masking layer 15 constitutes the distributor layer 30, while the portion of the single gradient/distributor layer that overlies the portion of the membrane 10 that is free to communicate with the fluid space 69 in the vessel 65 constitutes the gradient layer 20.

As used herein, the “self-supporting means” 50 are dimensioned to maintain a fluid space 69 between the bottom surface of the porous membrane 10 and the vessel surface 70, in a range from 10 μm to 500 μm, preferably in a range from 100 μm to 300 μm, when the micro-fluidic device 5 is disposed within the vessel 65 (see FIGS. 1G, 2E). This prevents the micro-fluidic device 5 from interfering with the cellular or tissue culture on the substrate surface 70 or cellular suspension in the fluid space 69 and allows for observation of any subsequently generated gradient 75 (see, e.g., FIGS. 1H, 2F, 3E).

The self-supporting means 50 may be fixedly attached to one or more of the membrane 10, the gradient layer 20 or the distributor layer 30. In one embodiment, the gradient layer 20, distributor layer 30 and self-supporting means 50 may be injection molded as a single continuous component. Alternatively, the self-supporting means could be removably coupled to one or more of the membrane 10, the gradient layer 20 or the distributor layer 30. Here, the self-supporting means 50 defines a chamber with sidewalls sized and shaped to receive the membrane 10, gradient layer 20 and distributor layer 30. The base of the chamber further defines an opening to allow at least the membrane 10 to interface with the fluid space 69 of the vessel 65. The self-supporting means 50 may be made out of PDMS, thermoset polymer, metal or any other suitable material.

Further, the self-supporting means 50 may comprise at least one of (a) a continuous sidewall coupled to a flange 50 to interface with a top edge 67 of a vessel 65 (FIGS. 1A, 1C-1G, 2A, 2C-2E, 3A, 3C-3D), (b) two or more sidewalls (not shown) each coupled to a flange to interface with a top edge 67 of a vessel 65, (c) a plurality of posts (not shown) disposed on a bottom surface of the microfluidic device 5 to interface with the bottom 70 of a vessel 65, (d) a threaded continuous sidewall (not shown) to interface with corresponding threads defined in a vessel 65, (e) two or more leaf-spring sidewalls biased outward (not shown) to interface with a continuous sidewall of a vessel, wherein the sidewalls are compressed inward to seat the microfluidic device 5 in the vessel 65, (f) a continuous sidewall or two or more sidewalls, wherein an exterior surface of each sidewall is coupled to an adhesive, or (g) a continuous sidewall or two or more sidewalls, wherein each sidewall is coupled to a clamp (not shown) to interface with one or more sidewalls of a vessel.

In one preferred embodiment, the porous membrane 10, the gradient layer 20, the distributor layer 30, the masking layer 15 and the self-supporting means 50 are all transparent. This permits real-time observations of cell morphology and migration during the course of an experiment.

In another preferred embodiment, the porous membrane 10, the gradient layer 20, the distributor layer 30, the masking layer 15 and the self-supporting means 50 are all opaque. In practice with epi-fluorescence microscopy, wherein the light source is deployed underneath the vessel 65, the opaque materials prevent excitation light from transmitting beyond the fluid space 69 and into the microfluidic device 5. In this manner the emitted fluorescent light that is collected beneath the vessel 65 originates from fluorescent species only in the fluid space 69.

In a second aspect, the present invention provides a method for generating a gradient 75 using the microfluidic device 5 of the first aspect of the invention, where the method comprises: (a) loading the microfluidic device's plurality of distributor micro-channels 35 and the plurality of gradient micro-channels 25 with at least a first fluid and a second fluid, wherein the first fluid and the second fluid are comprised of different concentrations of one or more soluble factors, (b) inserting the microfluidic device 5 into a vessel 65 containing fluid, (c) maintaining a fluid space 69, via the self-supporting means 50, between the bottom surface of the porous membrane 10 of the microfluidic device 5 and a surface 70 of the vessel 65, in a range from 10 μm to 500 μm, (d) diffusing the one or more soluble factors from the first and second fluids through the membrane 10 into the fluid space 69, and (e) generating a concentration gradient 75 in the fluid space 69. This method permits a user to control, for example, cellular differentiation, morphogenesis, metastasis, migration, proliferation, or other biological processes.

The first and second fluids are preferably cell culture mediums comprised of different concentrations of one or multiple soluble factors. These soluble factors comprise small molecules, growth factors, proteins, or other biological macromolecules, for example. A concentration gradient 75 (see, e.g., FIGS. 1H, 2F, 3E) is generated in the fluid space 69 of the vessel 65 via the diffusion of the soluble factors from the first and second fluid through the membrane 10.

The first and second fluids are deployed in the microfluidic device 5 through separate inlet openings 41, 42 and may be deployed through additional inlet openings 43, 44.

As used herein, “generating a concentration gradient” herein refers to the operation of the microfluidic device 5 so that the concentration of soluble factors are spatially controlled in the fluid space 69, where the generation of the concentration gradient 75 can be used to study chemotaxis (or other biological processes).

In one embodiment, the method further comprises: (a) substantially restricting fluid flow of the first and second fluids from the plurality of gradient micro-channels 25 through the membrane 10 into the vessel 65, and (b) reducing a fluid flow shear force in the fluid space 69 in response to restricting the fluid flow through the membrane 10. In practice, the porous membrane 10 permits fluid communication between the first and second fluids and the fluid space 69 by diffusion of soluble factors through substantially uniform pores, while at the same time acting as a barricade to prevent shear forces, which stem from fluid flow through the gradient micro-channels 25, from acting upon the fluid space 69. In other words, the first and second fluids do not substantially flow through the porous membrane 10 or accumulate in the vessel 65 over time. This in turn shields and protects cells and/or tissue disposed on the vessel surface 70.

In another embodiment, the method further comprises: repositioning the microfluidic device 5 in the vessel 65 by one or both of rotation or translation. Here, “rotation” means turning the microfluidic device 5 any number of degrees in substantially the same plane relative to the device's original position. “Translation,” in turn, means moving the microfluidic device 5 linearly relative to the device's original position. Translation in substantially the same plane as the vessel surface 70 enables repositioning the profile of the concentration gradient 75 relative to initial positions and cells and/or tissues. Translation in the direction normal the vessel surface 70 has the effect of changing the slopes of the concentration gradients as detected at the surface 70. In practice, this enables changing the orientation of concentration gradients 75 with respect to cells and/or tissue disposed on the vessel surface 70. Furthermore, manipulating the gradient 75 allows for the study of time and spatially-dependent aspects of chemotaxis, such as changes to cell migration, polarity, outgrowth, or other effects.

In still another embodiment, the method further comprises: (a) removing the microfluidic device 5 from the vessel 65, (b) loading the microfluidic device's plurality of distributor micro-channels 35 and plurality of gradient micro-channels 25 with at least a third fluid and a fourth fluid, wherein the third fluid and the fourth fluid are comprised of different concentrations of one or more soluble factors, (c) inserting the microfluidic device 5 into the vessel 65, and (d) diffusing the one or more soluble factors from the third and fourth fluids through the membrane 10 into the fluid space 69.

The third and fourth fluids are preferably cell culture mediums comprised of different concentrations of one or multiple soluble factors than that of the first and second fluids.

In one embodiment, the method further comprises: the concentration gradient 75 reaching a steady-state by moving the first fluid at a steady flow rate through a first inlet opening 41 defined in the top surface of the distributor layer 30 and moving the second fluid at a steady flow rate through a second inlet opening 42 defined in the top surface of the distributor layer 30, wherein a portion of the plurality of gradient micro-channels 26, 27 are coupled to the first inlet opening 41 and the remaining gradient micro-channels 28 are coupled to the second inlet opening 42.

The flow rates for the first and second fluid may be the same or different. The fluid flow rates can range from 10 nl/hour to 1000 μl/hour and are preferably in the range from 20 μl/hour to 200 μl/hour.

In yet another embodiment, the method further comprises: (a) removing the microfluidic device 5 from the vessel 65, and (b) placing a second microfluidic device 5 into the vessel 65, wherein the second microfluidic device 5 defines a different gradient micro-channel pattern 25 than the removed microfluidic device 5. For example, the first micro-fluidic device may have a parallel arrangement of the gradient micro-channels 25 (FIGS. 1A-2G, 2A-2E) and the second micro-fluidic device may have a perpendicular arrangement of the gradient micro-channels 25 (FIGS. 3A-3D).

In a third aspect, the present invention provides a method for controlling the delivery of soluble factors to cell cultures using the microfluidic device of the first aspect of the invention, where the method comprises: (a) loading the microfluidic device's plurality of distributor micro-channels 35 and the plurality of gradient micro-channels 25 with a fluid containing one or more soluble factors, (b) inserting the microfluidic device 5 into a vessel 65 containing fluid, (c) maintaining a fluid space 69, via the self-supporting means 50, between a bottom surface of the porous membrane 10 and a surface 70 of the vessel 65 in a range from 10 μm to 500 μm, (d) diffusing the one or more soluble factors from the fluid through the membrane 10 into the fluid space 69, and (e) maintaining a substantially uniform concentration of soluble factors at the surface of the vessel 65.

This method provides for the delivery of soluble factors in a substantially uniform manner for long-term culture of biological samples, cell cultures, or tissue cultures over a period of days by the diffusive transport and supply of fresh medium and removal of waste between the fluid space 69 and the microfluidic device 5.

All embodiments of the microfluidic device 5 of the invention can be used in the methods of the second and third aspects of the invention.

Note that any of the foregoing embodiments of any aspect may be combined together to practice the claimed invention.

### EXAMPLE

### Gradient Generation

### Device Setup

The microfluidic device 5 is pre-loaded with solutions through tubing and syringes connected to a dual-barreled syringe pump (Nexus, Chemyx Inc., Stafford, Tex.) before application. To generate a gradient 75, the microfluidic device 5 is loaded with a buffer and a solution containing the soluble factor of interest. To apply the microfluidic device 5 to a substrate, the device 5 is placed into a well 66 in a 6-well plate 65 pre-filled with a small volume of fluid (1-2 ml). The modular design serves two important purposes for device operation: (1) it frees the substrate from the microfluidic device 5 to simplify cell culture and (2) it allows us to introduce gradients of soluble molecules at any point in time to pre-established cell cultures. In this example, the microfluidic device 5 is operated at flow rates of 100 μl/hr to 200 μl/hr over the course of several hours. In a specific instance, flow rates of 100 μl/hr and 1000 μl/hr were applied differentially to the each input; no noticeable deformation of the gradient 75 was observed. For the course of an experiment that lasts for several days, the volume of medium and reagent exchanged is on the order of a couple milliliters. The negligible net flow into the well 66 and the low influence of the pump rate both indicate that the microfluidic device 5 operates in a regime where the Peclet number, a dimensionless ratio of convection to diffusion, is close to zero. With this evidence, the microfluidic device operation was simplified even further with pump-less flow schemes. The two methods demonstrated the operation of the microfluidic device 5 with gravity-driven flow either through on-chip or on-plate reservoirs. Specifically, on-chip reservoirs fashioned from syringe connectors served to generate gradients 75 for up to 4 hours without refilling, whereas on-plate reservoirs have a significantly greater volume available and can generate gradients 75 for up to 10 hours without refilling. The on-plate reservoirs employed short segments of tubing and enabled the syphoning of flow to and from adjacent wells.

### Characterization of Surface-Level Gradients

Surface-level gradients 75 were quantified using an imaging technique for adapting regular epi-fluorescence microscopy to collect surface-level intensity. The penetration length of the excitation light into the sample was limited by flowing a mixture of non-fluorescent and fluorescent dyes, Orange-G and fluorescein, respectively. The dyes were chosen because Orange-G absorbs strongly at the excitation wavelength (490 nm) and weakly at the emission wavelength of fluorescein (540 nm). In combination, the dyes compete for a finite amount of excitation energy. With a concentration of 45 mM for Orange-G the characteristic penetration length is approximately 4.9 μm (for which the excitation light intensity is 1/e times the incident intensity of the excitation light). Since the intensity of the excitation light decays exponentially as it penetrates the solution, 95% of the collected emission light is from within 15 μm of the surface of the well plate. Using this technique, the stability and uniformity of gradients 75 generated by microfluidic devices 5 were characterized. In Charts 1 and 2, the fluorescence results are shown for 16-channel and 8-channel versions of the microfluidic device 5 with a parallel arrangement such as shown in FIGS. 1-2. The devices were shown to be stable over the course of 72 hours of operation.

(Chart 1: Surface gradient characterization of a 16-channel device designed for standard 6-well plates. A mixture of fluorescein at 1 mg/ml was delivered from one set of channels in a medium of 45 mM Orange G. Surface fluorescence was collected from an approximately 15 μm optical slice at the surface of the 6-well plate after 72 hours of operation. Seventy-four images were taken in 206 μm increments moving along the vertical direction to capture the entire gradient area at 4× magnification. Fluorescence intensity was plotted for a 12×12 pixel area taken in the center of each of the images to characterize the gradient profile in the three separate areas along the width of the device.)

(Chart 2: Surface gradient characterization of an 8-channel device designed for glass-bottom 6-well plates. Using a more advanced microscopy setup enabled rapid image stitching of the entire gradient area. The average intensity profile was plotted for a horizontal cross-section of the fluorescence image.)

### Calcein AM Staining of Confluent CHO-K1 Cell Cultures

An intracellular fluorescent stain, Calcein AM, was used in order to demonstrate the benign application of the microfluidic device 5 for gradient delivery to cell cultures. Calcein AM (#C3100MP, Life Technologies, Grand Island, N.Y., USA) is a cell-permeable dye that enters the cytosol of cells through an acetoxymethyl ester. Intracellular esterases of viable cells cleave the AM group and the calcein becomes brightly green-fluorescent (Ex/Em=490 nm/520 nm). In an assay, a culture of CHO-K1 cells (#CCL-61, ATCC, Manassas, Va., USA) was grown on a glass-bottom 6-well plate and exposed to a gradient of calcein AM for 20 min by the 8-channel device (see Chart 3). The results of this experiment emphasize that the microfluidic device 5 can be operated as a plug-and-play platform that is suitable for gradient delivery to a large quantity of viable cells. For this experiment the exposure time was limited to 20 minutes in order to prevent over-staining of cells; however long term application is possible. The fluorescence intensity profiles in Chart 3 are correlated to the amount of intracellular dye absorbed over the course of the experiment. An exponential fluorescence profile is produced because the intracellular calcein of the cells is the integration of a linear extracellular gradient over the time of exposure.

(Chart 3: Calcein AM green staining of a nearly confluent layer of CHO-K1 cells with a microfluidic device 5 demonstrates a gradient in the uptake of dye. A wide-area stitched fluorescent image was captured after application and removal of the microfluidic device 5. The brightest cells were in closest proximity to the Calcein AM source channels, whereas the un-stained cells were nearest the sink channels and are not visible in the fluorescence image. Fluorescence intensity profiles are shown for the left, middle, and right regions spaced by 5 mm apart for the image showing the characteristic gradient of calcein stained CHO-K1 cells.)

### Guidance of Axon Outgrowth in Embryonic Retinal Explant Cultures

A preliminary study demonstrated the application of the microfluidic device 5 to an E14 embryonic mouse retinal explant. The explant was cultured in a glass-bottom 6-well plate 65 using standard culture protocol for 4 days in vitro before the microfluidic device 5 was applied to generate a gradient 75. The microfluidic device 5 was applied and a uniform concentration of medium containing growth factors was delivered for 24 hours during which the explant projected visible outgrowth of neuronal processes containing axons and growth cones. Then the microfluidic device 5 was rotated at 45 degrees relative to the majority of existing outgrowth and reconfigured with one fluid containing additionally a cell membrane permeable cyclic adenosine monophosphate (cAMP) analog Sp-8-Br-cAMP at a concentration of 20 μM. This analog of cAMP was chosen, because it is a key mediator of growth cone responses to a number of extracellular guidance molecules and previously implicated in micropipette-based studies with single neurons. The time-lapse images demonstrated visible axon outgrowth in the direction of the gradient source that can be interpreted as a guidance or turning response (see Chart 4).

(Chart 4: Traces of axon growth cones from a retinal explant cultured in the presence of an 8-Br-cAMPS gradient over the course of 13 hours. A large area stitched phase-contrast image showed the positioning of an E14 embryonic mouse retinal explant with a microfluidic device 5 placed in the well 66 above the tissue. The source and sink channels were visible at the edges of the image area. Axon outgrowth in the direction of the gradient source was visible at 15 hours of exposure to 20 μM 8-Br-cAMPS, a membrane permeable cyclic-AMP analog. Over the course of 13 hours the outgrowth occurred in the direction of the gradient source. Individual trajectories of growth cones were traced and plotted.)

### Guidance of Axon Outgrowth in Dissociated Cultures of Embryonic Hippocampal Neurons

Another study demonstrated the application of the microfluidic device to primary hippocampal neurons from E18 mouse. A gradient of 20 μM Sp-8-Br-CAMPs was applied for 6 hours to elicit axon guidance (see Chart 5). Overall, cells showed viability while interfaced with the device for periods over 24 hours as evidenced by active growth cones.

(Chart 5: Traces of axon growth cones of E18 embryonic hippocampal neurons in response to a gradient of 8-Br-cAMPS over the course of 24 hours. Image sequences for growth spurts of typical active neurons were observed. Axon growth cone traces generated from MATLAB image analysis are shown for 10 neurons that were exposed to a gradient of 8-Br-cAMP. With automated time-lapse imaging, the growth activity of approximately 1000 cells was imaged in 20 min intervals across an area comprised of 300×20 fields of view using 20×magnification.)

1. A microfluidic device comprising:
a porous membrane;
a gradient layer defining a plurality of gradient micro-channels, wherein the gradient layer is coupled to a top surface of the membrane;
a distributor layer defining a plurality of distributor micro-channels, wherein the distributor micro-channels are coupled to the plurality of gradient micro-channels, wherein the distributor layer defines at least one inlet opening and at least one outlet opening, each inlet opening and outlet opening coupled to the plurality of distributor micro-channels; and
self-supporting means coupled to one or more of the porous membrane, the gradient layer and the distributor layer.

2. The device of claim 1, wherein the porous membrane defines substantially uniform sized pores that are aligned in a substantially straight path from the top surface of the porous membrane to a bottom surface of the porous membrane.

3. The device of claim 3, wherein the substantially uniform sized pores have a nominal diameter ranging from 20 nm to 14 μm.

4. The device of claim 1 further comprising:
a masking layer coupled to the porous membrane.

5. The device of claim 4, wherein the masking layer is aligned under the plurality of distributor micro-channels.

6. The device of claim 4, wherein the masking layer is coupled to a bottom surface of the porous membrane and the distributor layer is coupled to the top surface of the porous membrane.

7. The device of claim 1, wherein the distributor layer and the gradient layer have a stacked arrangement such that the gradient layer is disposed between the distributor layer and the porous membrane, wherein the gradient layer acts as a masking layer, and wherein the plurality of distributor micro-channels are coupled to the plurality of gradient micro-channels via ducts.

8. The device of claim 1, wherein the self-supporting means comprises at least one of (a) a continuous sidewall coupled to a flange to interface with a top edge of a vessel, (b) two or more sidewalls each coupled to a flange to interface with a top edge of a vessel, (c) a plurality of posts disposed on a bottom surface of the microfluidic device to interface with the bottom of a vessel, (d) a threaded continuous sidewall to interface with corresponding threads defined in a vessel, (e) two or more leaf-spring sidewalls biased outward to interface with a continuous sidewall of a vessel when the sidewalls are compressed inward, (f) a continuous sidewall or two or more sidewalls, wherein an exterior surface of each sidewall is coupled to an adhesive, or (g) a continuous sidewall or two or more sidewalls, wherein each sidewall is coupled to a clamp to interface with one or more sidewalls of a vessel.

9. The device of claim 1, wherein the plurality of gradient micro-channels are substantially parallel to one another.

10. The device of claim 9, wherein a top surface of the distributor layer defines a first inlet opening and a second inlet opening and defines a first outlet opening and a second outlet opening, wherein the plurality of parallel gradient micro-channels are arranged such that a first gradient micro-channel and every other micro-channel thereafter is coupled to both the first inlet opening and the first outlet opening, while the remaining gradient micro-channels are coupled to both the second inlet opening and the second outlet opening.

11. The device of claim 1, wherein a top surface of the microfluidic device defines a first inlet opening and a second inlet opening and defines a first outlet opening and a second outlet opening, wherein a portion of the gradient micro-channels coupled to both the first inlet opening and the first outlet opening are substantially perpendicular to a portion of the gradient micro-channels coupled to both the second inlet opening and the second outlet opening.

12. The apparatus of claim 1, wherein the porous membrane, the gradient layer, the distributor layer, and the self-supporting means are all transparent.

13. The apparatus of claim 1, wherein the porous membrane, the gradient layer, the distributor layer, and the self-supporting means are all opaque.

14. A method for generating a gradient using the microfluidic device of claim 1, the method comprising:
loading the microfluidic device's plurality of distributor micro-channels and the plurality of gradient micro-channels with at least a first fluid and a second fluid, wherein the first fluid and the second fluid are comprised of different concentrations of one or more soluble factors;
inserting the microfluidic device into a vessel containing fluid;
maintaining a fluid space in a range from 10 μm to 500 μm in height, via the self-supporting means, between a bottom surface of the porous membrane and a surface of the vessel;
diffusing the one or more soluble factors from the first fluid and the second fluid through the porous membrane into the fluid space; and
generating a concentration gradient in the fluid space.

15. The method of claim 14, further comprising the steps of:
substantially restricting fluid flow of the first fluid and the second fluid from the plurality of gradient micro-channels through the membrane into the vessel; and
in response to restricting the fluid flow through the membrane, reducing a fluid flow shear force in the fluid space.

16. The method of claim 14, further comprising the step of:
after generating the concentration gradient, repositioning the microfluidic device in the vessel by one or both of rotation or translation.

17. The method of claim 14, further comprising the steps of:
removing the microfluidic device from the vessel;
loading the microfluidic device's plurality of distributor micro-channels and plurality of gradient micro-channels with at least a third fluid and a fourth fluid, wherein the third fluid and the fourth fluid are comprised of different concentrations of one or more soluble factors;
inserting the microfluidic device into the vessel; and
diffusing the one or more soluble factors from the third fluid and the fourth fluid through the porous membrane into the fluid space.

18. The method of claim 14, further comprising the step of:
the concentration gradient reaching a steady-state by moving the first fluid at a steady flow rate through a first inlet opening defined in a top surface of the distributor layer and moving the second fluid at a steady flow rate through a second inlet opening defined in the top surface of the distributor layer, wherein a portion of the plurality of gradient micro-channels are coupled to the first inlet opening and the remaining gradient micro-channels are coupled to the second inlet opening.

19. The method of claim 14, further comprising the step of:
removing the microfluidic device from the vessel; and
placing a second microfluidic device into the vessel, wherein the second microfluidic device defines a different gradient micro-channel pattern than the removed microfluidic device.

20. A method for controlling the delivery of soluble factors to cell cultures using the microfluidic device of claim 1, the method comprising:
loading the microfluidic device's plurality of distributor micro-channels and the plurality of gradient micro-channels with a fluid containing one or more soluble factors;
inserting the microfluidic device into a vessel containing fluid;
maintaining a fluid space in a range from 10 μm to 500 μm in height, via the self-supporting means, between a bottom surface of the porous membrane and a surface of the vessel;
diffusing the one or more soluble factors from the fluid through the porous membrane into the fluid space; and
maintaining a substantially uniform concentration of soluble factors at the surface of the vessel.
